(19) United States
(12) Patent Application Publication
(10) Pub. No.: US 2018/0172415 A1
(43) Pub. Date: Jun. 21, 2018

(54) MULTI-FUNCTION RULER

(71) Applicants: Chi-Ming Chu, New Taipei City (TW); Heng Chang, New Taipei City (TW); Yu-Lin Wang, Taoyuan City (TW)

(72) Inventors: Chi-Ming Chu, New Taipei City (TW); Heng Chang, New Taipei City (TW); Yu-Lin Wang, Taoyuan City (TW)

(21) Appl. No.: 15/382,427

(22) Filed: Dec. 16, 2016

(51) Int. Cl. G01B 3/04; G01B 3/00

(52) U.S. Cl. CPC G01B 3/04; G01B 3/002

(57) ABSTRACT

A multi-function ruler is provided with a rectangular, transparent body; at least one opening through a top and an underside of the body; and at least one row of a plurality of equally spaced markings printed along one side of the body. The at least one opening includes at least one directional sign, at least one curve, and at least one figure.

### BACKGROUND OF THE INVENTION

### 1. Field of the invention

The invention relates to rulers and more particularly to a multi-function ruler, in addition to drawing a straight line, being capable of drawing different directional signs, curves and figures.

### 2. Description of Related Art

Conventionally, an architect may use a plurality of different rulers to draw straight lines, curves, figures, etc. in work. This is inconvenient and may consume time.

However, there is no single ruler capable of drawing different directional signs, curves and figures commercially available.

Thus, the need for improvement still exists.

### SUMMARY OF THE INVENTION

It is therefore one object of the invention to provide a ruler comprising a transparent body; at least one opening through a top and an underside of the body; and at least one row of a plurality of equally spaced markings printed along one side of the body.

Preferably, the body is rectangular.

Preferably, the at least one opening includes at least one directional sign, at least one curve, and at least one figure.

The invention has the following advantages: An individual may use the ruler to draw straight lines, different curves, and different figures on a paper. The individual may clearly see the opening being pointed by the pen and what is being drawn by the pen through the transparent body.

### BRIEF DESCRIPTION OF THE DRAWINGS

The invention, as well as its many advantages, may be further understood by the following detailed description and drawings in which:

FIG. 1 is a view of a multi-function ruler according to the invention.

### DETAILED DESCRIPTION OF THE INVENTION

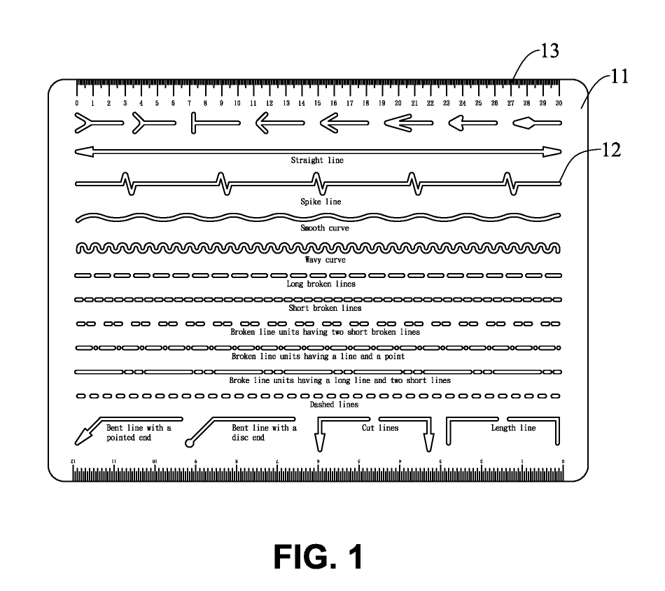

Referring to FIG. 1, a multi-function ruler in accordance with the invention comprises a rectangular body 11, a plurality of openings 12 and a plurality of equally spaced markings 13 as discussed in detail below.

The body 11 is made of transparent material. The opening 12 passes through a top and an underside of the body 11. The markings 13 are printed along one of four sides of the body 11 for measuring distance of a figure drawn on a paper (not shown) along one of the openings 12.

As shown, the openings 12 include a plurality of different directional signs, a plurality of different curves, and a plurality of different figures.

In use, in addition to drawing a straight line along one of the four straight edges of the ruler, an individual may draw a figure on a paper (not shown) by using a pen (not shown) to draw along one of the openings 12. Also, the individual may clearly see what is being drawn by the ruler on the paper because the body 11 is transparent. Further, the markings 13 may help the individual measure distance of the drawn figure.

The markings 13 consist of a first row of markings of SI (International System of Units) unit (e.g., cm) and a second row of markings of imperial unit (e.g., inch).

The invention has the following advantages in comparison with the conventional rulers:

An architect (or any individual) may use the ruler to draw straight lines, different curves, and different figures on a paper.

The architect may clearly see the opening 12 being pointed by the pen and what is being drawn by the pen through the transparent body 11.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A ruler comprising:
a transparent body;
at least one opening through a top and an underside of the body; and
at least one row of a plurality of equally spaced markings printed along one side of the body.

2. The ruler of claim 1, wherein the body is rectangular.

3. The ruler of claim 1, wherein the at least one opening includes at least one directional sign, at least one curve, and at least one figure.
